(19) United States
(12) Patent Application Publication
(10) Pub. No.: US 2025/0285070 A1
(43) Pub. Date: Sep. 11, 2025

(54) TRANSMISSION OF ELECTRONIC MEDIA

(71) Applicant: Veho Tech, Inc., Claymont, DE (US)

(72) Inventors: Azeem Ahmed, Irving, TX (US); Ophus Wong, Denver, CO (US); Ross Gaither, Freehold, NY (US); Fred Cook, Denver, CO (US); John Farley, Portland, OR (US)

(73) Assignee: Veho Tech, Inc., Claymont, DE (US)

(21) Appl. No.: 19/066,945

(22) Filed: Feb. 28, 2025

Related U.S. Application Data
(60) Provisional application No. 63/563,213, filed on Mar. 8, 2024.

(51) Int. Cl. G06Q 10/0832; G06T 19/00

(52) U.S. Cl. CPC G06Q 10/0832; G06T 19/006

(57) ABSTRACT

Systems and methods for providing visual media for package delivery may include requesting the visual media from a customer, uploading the visual media to a database, recording a location of the visual media, receiving a request for the visual media, locating the visual media based on the recorded location of the visual media, and providing the visual media either in real time or for download.

### CROSS REFERENCE TO RELATED APPLICATIONS

This application claims the benefit of priority to U.S. Provisional Patent Application No. 63/563,213, filed on Mar. 8, 2024, entitled “SYSTEMS AND METHODS FOR IMPROVED PACKAGE PLACEMENT,” the entire contents of which are hereby incorporated by reference herein in their entirety.

### BACKGROUND

Package delivery services have traditionally relied on text-based delivery instructions, which often lead to misinterpretation and misplacement of packages. Despite advances in tracking technology, delivery personnel continue to struggle with ambiguous instructions such as “leave by the side door” or “place behind planter,” resulting in packages being left in unintended locations, exposed to weather, or creating accessibility obstacles. These misplacements not only impact customer satisfaction but also lead to increased costs due to package damage, theft, and redelivery attempts.

Previous attempts to address this challenge have included allowing customers to upload delivery photos or provide detailed text descriptions. However, these solutions fail to provide real-time guidance to delivery personnel and lack the precision needed for exact package placement. Additionally, existing systems do not account for package-specific requirements, such as size constraints or orientation preferences, leading to situations where packages block access ways or fail to meet customer expectations for discretion and security.

The rise of augmented reality (AR) technology has created new possibilities for spatial communication and guidance, yet current delivery systems have not effectively leveraged these capabilities for package placement. While some delivery services have implemented basic photo-sharing features, they have not integrated real-time verification systems or provided interactive guidance to ensure accurate package placement. This gap between available technology and implementation has left a significant need for more precise and reliable package delivery solutions.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

When a customer orders a package, the customer has expectations about where the package will be placed upon delivery. These customer expectations may include preferences, security concerns, and disability accommodations. For example, a customer may expect a package to be placed so it is hidden from the street or placed so as to not block a wheelchair ramp. Customers may attempt to relay customer expectations via written delivery instructions. However, customers may struggle to adequately describe their delivery expectations, and delivery personnel may struggle to understand and comply with the delivery expectations.

Misdeliveries not only hurt a business' bottom line, but also damage customer satisfaction and brand image. There may be a correlation between misdeliveries (alongside missed instructions and bad package placement) and low customer satisfaction scores.

Embodiments discussed herein provide for systems and methods for seamless and streamlined sharing of visual media for describing customer delivery expectations. The visual media may include photos, geolocation, and/or augmented reality (AR) overlays. A customer may upload the visual media showing their delivery expectations to be accessed by a delivery driver when delivering a package. The visual media may describe clearly, and with exactness, where the package is to be delivered, allowing for more accurate package placement.

Giving customers greater control over where their packages are delivered may significantly reduce misdeliveries, improve customer satisfaction, and ultimately enhance brand reputation.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is an example user interface including an order indication.

FIG. 2 is an example user interface for updating delivery instructions.

FIG. 3 is an example user interface for updating delivery instructions.

FIG. 4 is an example user interface for uploading a photo for delivery instructions.

FIG. 5 is an example user interface for updating delivery instructions including the photo of FIG. 4.

FIG. 6 is an example user interface for updating delivery instructions.

FIG. 7 is an example user interface for receiving delivery instructions.

FIG. 8 is an example user interface for comparing delivery instructions to a physical location.

FIG. 9 is an example user interface for comparing delivery instructions to a physical location.

FIG. 10 is an example block diagram of a system for uploading visual media for delivery instructions.

FIG. 11 is an example block diagram of a system for downloading visual media for delivery instructions.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

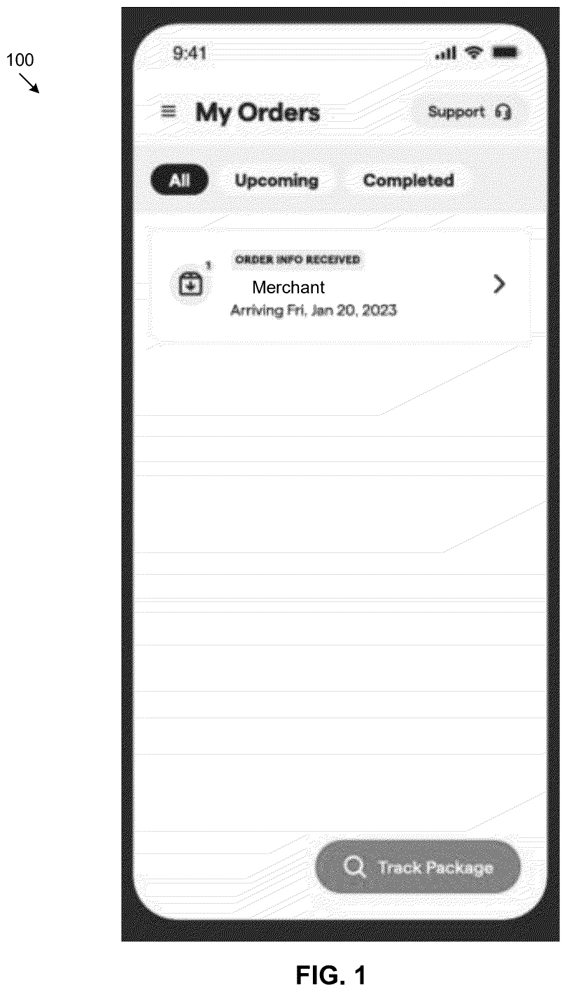

FIG. 1 is an example user interface 100 including an order indication. The user interface 100 may be a user interface of a mobile application for a customer. The user interface 100 may include a summary of orders for the customer. The user interface 100 may allow the customer to select an order to view additional information about the order and provide delivery instructions for the order.

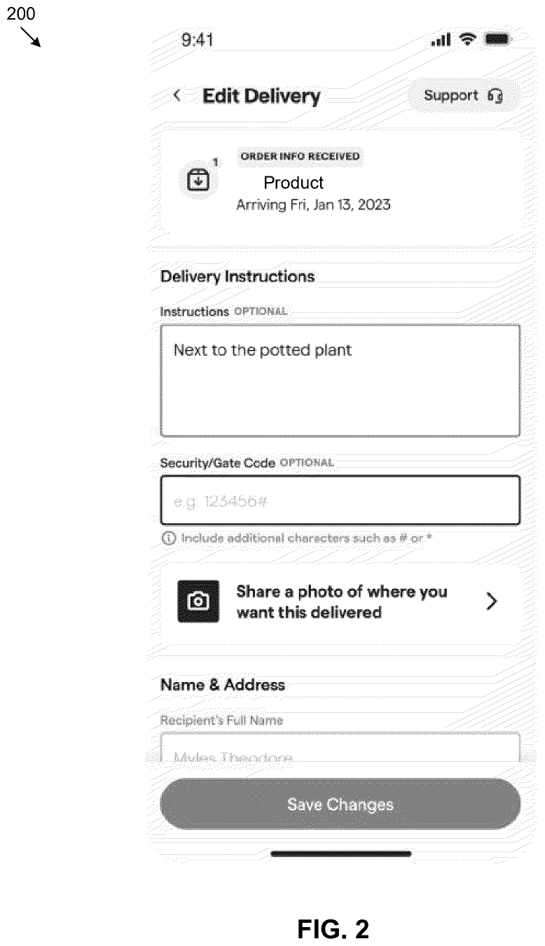

FIG. 2 is an example user interface 200 for updating delivery instructions. The user interface 200 may be a user interface of a mobile application for a customer. The user interface 200 may include a field for entering text for the delivery instructions. The user interface 200 may include a field or button for uploading a photo for the delivery instructions.

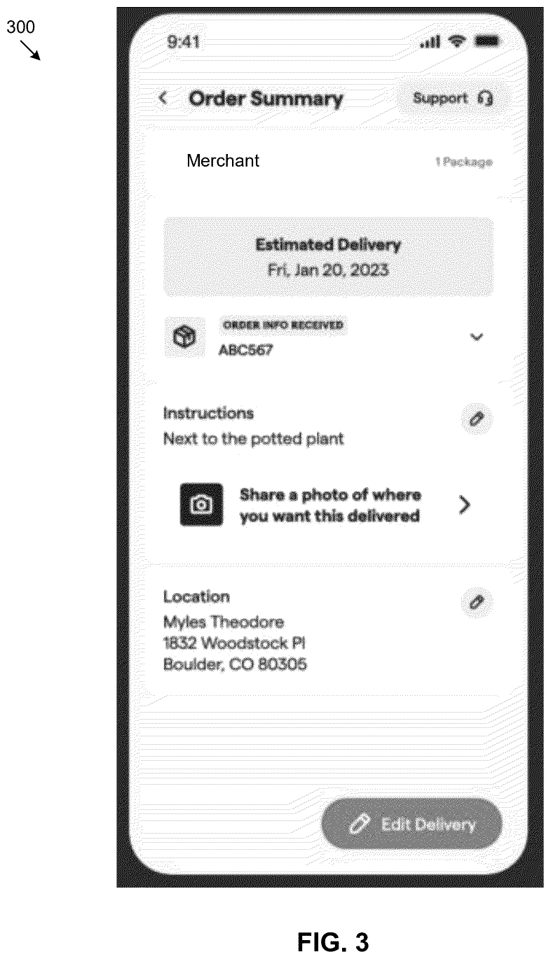

FIG. 3 is an example user interface 300 for updating delivery instructions. The user interface 300 may be a user interface of a mobile application for a customer. The user interface 300 may include a field for entering text for the delivery instructions. The user interface 300 may include a field or button for uploading a photo for the delivery instructions.

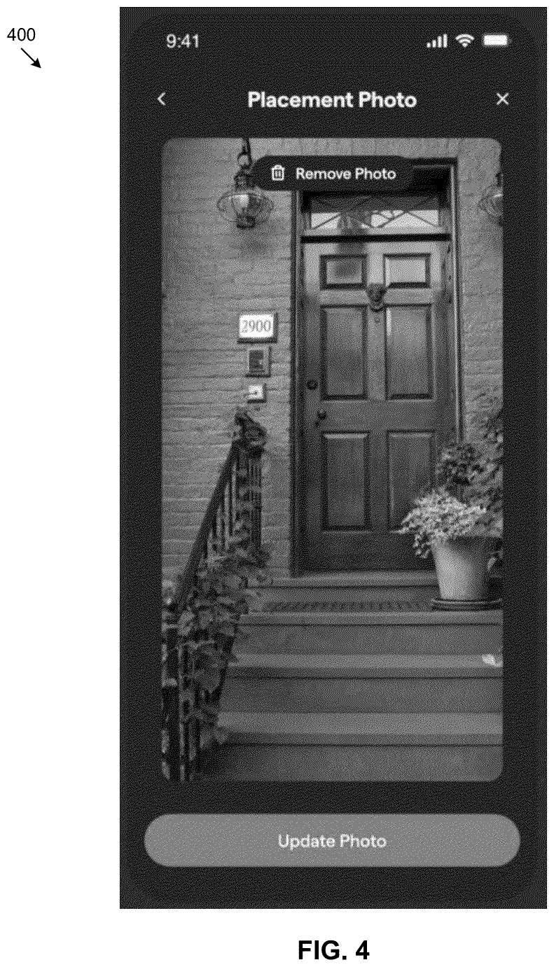

FIG. 4 is an example user interface 400 for uploading a photo for delivery instructions. The user interface 400 may be a user interface of a mobile application for a customer. The user interface 400 may allow a customer to take a photo and/or select a photo from existing photos. The user interface 400 may allow the customer to confirm the photo for the delivery instructions or retake the photo. In some implementations, the photo includes a geolocation of a mobile device of the customer. In some implementations, when uploading the photo, the mobile device of the customer attaches, includes, or transmits the geolocation of the mobile device. In some implementations, the user interface 400 allows the customer to confirm and/or edit the geolocation associated with the photo.

In some implementations, the photo includes a digital representation of a package, such as a package having dimensions and characteristics of a package associated with the order. The user interface 400 may allow the customer to move, rotate, and otherwise position the digital representation of the package within the photo. In this way, the customer can specify exactly where the customer wants the package to be placed without having to describe the package placement in text. The digital representation of the package may be fixed in three-dimensional space, allowing for use of the digital representation of the package in AR applications.

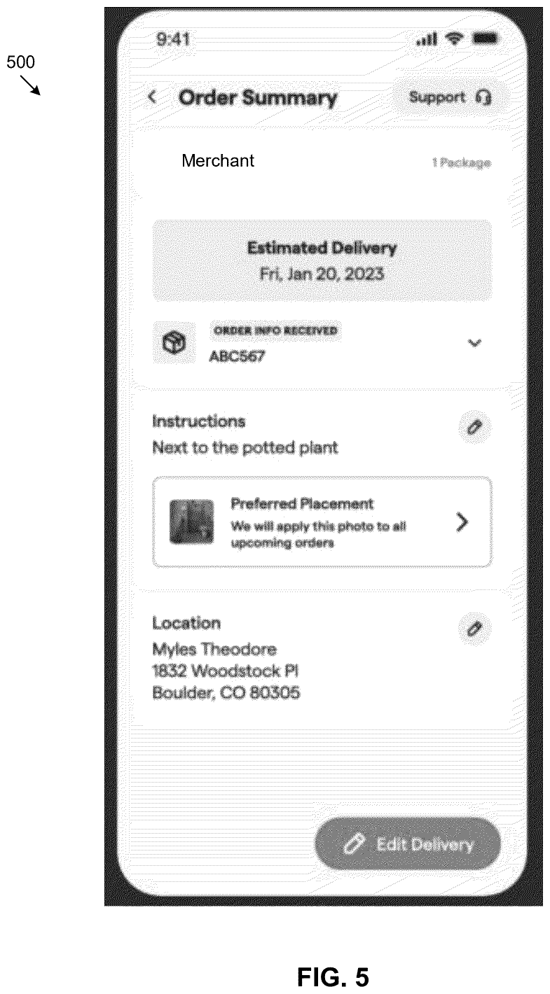

FIG. 5 is an example user interface 500 for updating delivery instructions including the photo of FIG. 4. The user interface 500 may be a user interface of a mobile application for a customer. The user interface 500 may include text for the delivery instructions and the photo for the delivery instructions.

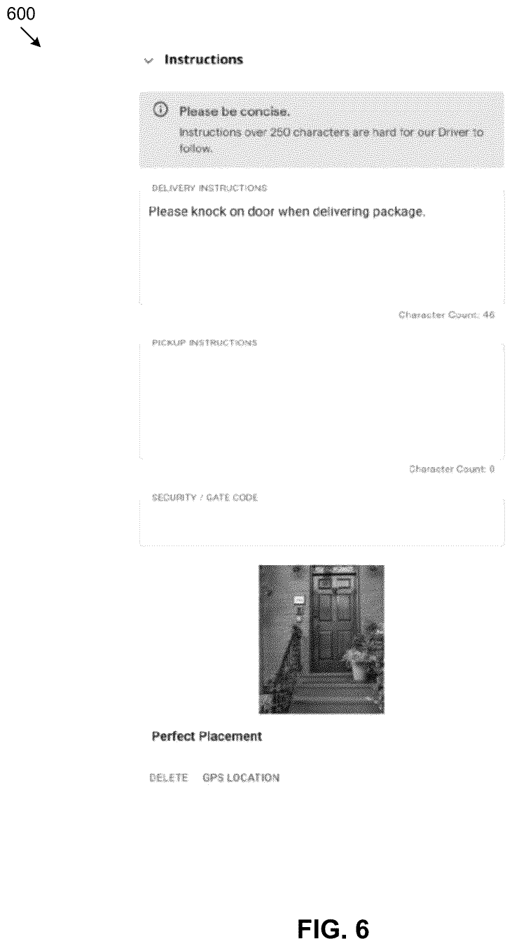

FIG. 6 is an example user interface 600 for updating delivery instructions. The user interface 600 may be a user interface of a mobile application for a customer. The user interface 600 may include fields for updating delivery instructions for a package. The user interface 600 may include the photo of FIG. 4. The user interface 600 may include buttons for editing or deleting the photo. The user interface 600 may include a button for adding a geolocation to the photo or to the delivery instructions.

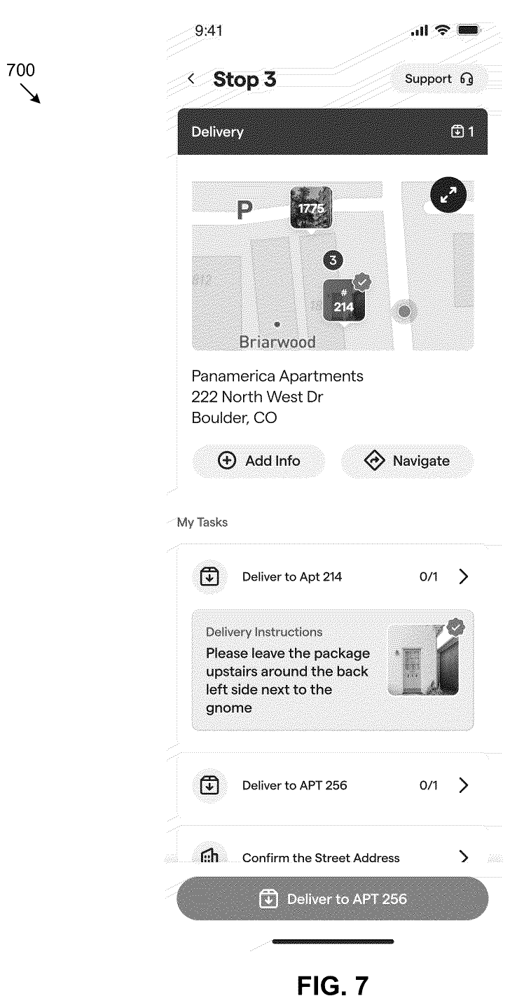

FIG. 7 is an example user interface 700 for receiving delivery instructions. The user interface 700 may be a user interface of a mobile application for a delivery person. The user interface 700 may include a geolocation of an address of a customer. The user interface 700 may include delivery instructions provided by the customer for delivery of a package. The delivery instructions may include text and/or a photo provided by the customer. The delivery instructions may include a geolocation, such as a geolocation of the photo or of a mobile device which provided the photo. In some implementations, the mobile application for the delivery person compares the geolocation of the address and the geolocation of the photo to verify an accuracy of the geolocation of the photo. In some implementations, a server compares the geolocation of the address and the geolocation of the photo to verify the accuracy of the geolocation of the photo.

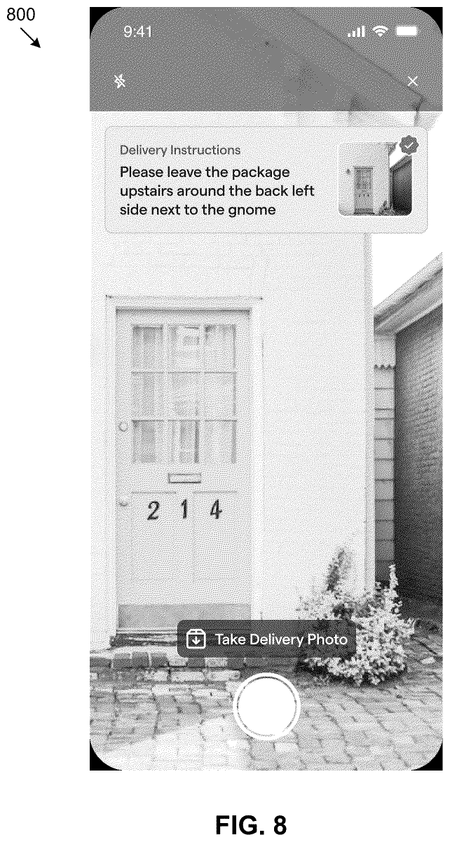

FIG. 8 is an example user interface 800 for comparing delivery instructions to a physical location. The user interface 800 may be a user interface of a mobile application for a delivery person. The user interface 800 may include a photo provided by a customer for delivery instructions. The user interface 800 may include text provided by a customer for delivery instructions. In some implementations, the user interface 800 includes a digital representation of a package to be delivered. The digital representation may be placed within the photo to illustrate where the package should be placed. In some implementations, the user interface 800 may provide an AR overlay of a delivery location to show the delivery person where to place the package. The AR overlay may fix the digital representation of the package in three-dimensional space to provide an exact indication of the package placement. The AR overlay may provide real-time feedback to a delivery person. The location of the digital representation of the package may be compared to the placement of the physical package to determine whether the physical package is placed in accordance with the delivery instructions. In an example, the delivery person uses an application on a mobile device to view a delivery area and see the digital representation of the package in the delivery area. In this example, the delivery person places the physical package in the delivery area where the digital representation is shown in the AR overlay and receives feedback on whether the placement of the physical package corresponds to the location of the digital representation of the package. The mobile application may provide real-time feedback to the delivery person regarding the placement of the physical package. The mobile application may indicate whether the physical package is placed in the location of the digital representation of the package and/or provide suggestions for moving or orienting the physical package (e.g., text or arrows showing a direction of movement).

The delivery person may place the physical package such that the physical package is superimposed on the location of the digital representation of the package and upload a photo of the physical package's placement to a server. The server may determine whether the physical package is placed in the location of the digital representation of the package, with a predetermined tolerance, and transmit approval or denial to the delivery person.

In some implementations, the mobile application of the delivery person may guide the delivery person to the delivery area. In an example, the mobile application may provide an AR overlay to the delivery person with a path or arrows indicating directions to the delivery area (e.g., based on a geolocation of the delivery area).

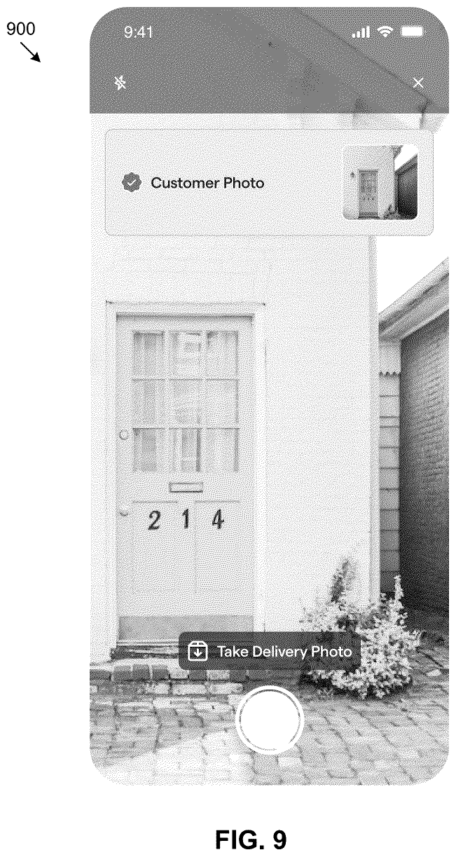

FIG. 9 is an example user interface 900 for comparing delivery instructions to a physical location. The user interface 900 may be a user interface of a mobile application for a delivery person. The user interface 900 may include a photo provided by a customer for delivery instructions. In some implementations, the user interface 900 includes a digital representation of a package to be delivered. The digital representation may be placed within the photo to illustrate where the package should be placed. In some implementations, the user interface 900 may provide an AR overlay of a delivery location to show the delivery person where to place the package. The AR overlay may fix the digital representation of the package in three-dimensional space to provide an exact indication of the package placement.

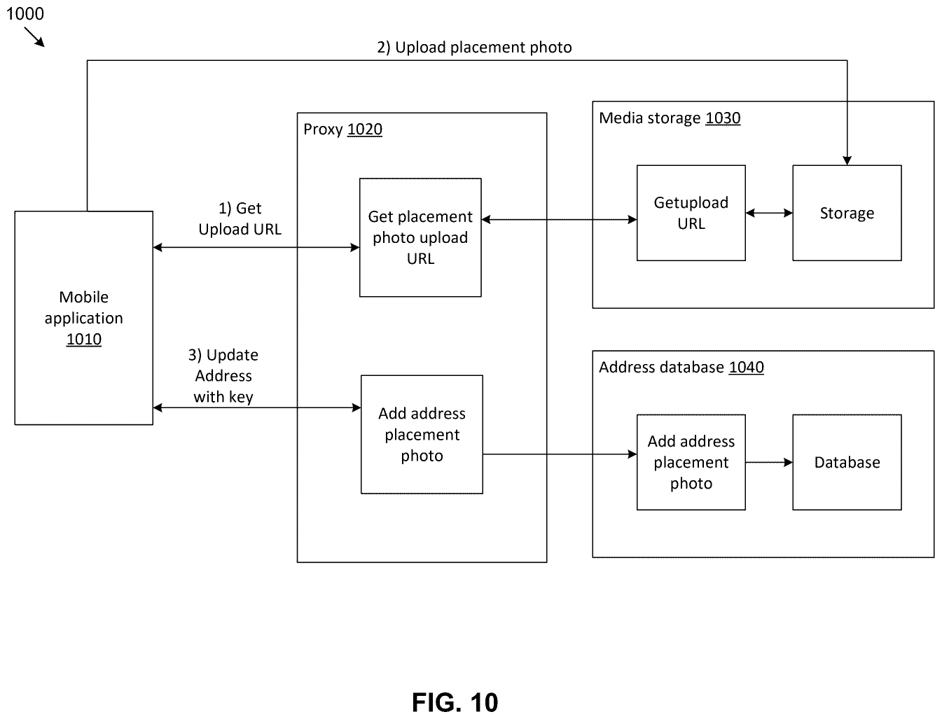

FIG. 10 is an example block diagram of a system 1000 for uploading media for delivery instructions. The system 1000 includes a mobile application 1010, a media storage 1030, and an address database 1040 storing customer addresses (i.e., geographic locations). In some implementations, the system 1000 includes a proxy 1020. In an example, the mobile application 1010 is a mobile application of a customer which communicates with the proxy 1020 to protect the media storage 1030 and the address database 1040 from malicious requests. In an example, the mobile application 1010 is a mobile application of a delivery person which communicates with the proxy 1020 to protect the media storage 1030 and the address database 1040 from malicious requests. In some implementations, the proxy 1020 includes separate proxies for each of the customer mobile application and the driver mobile application.

The mobile application 1010 may request an upload URL from the media storage 1030. In some implementations, the mobile application 1010 requests the upload URL from the proxy 1020 which requests the upload URL from the media storage 1030. In an example, the mobile application 1010 is a mobile application of a customer and the request is routed through the proxy 1020 to authenticate the customer and protect the media storage 1030 from malicious requests. In some implementations, the proxy 1020 modifies the request from the mobile application 1010 for delivery to the media storage 1030.

The media storage 1030 may be a cloud storage, such as one or more AWS S3 buckets. The media storage 1030 may respond to the request from the mobile application 1010 with the upload URL. The upload URL may allow for uploading of media to the media storage 1030. In some implementations, the upload URL includes a key identifying a location in the media storage 1030 where the media will be stored.

The mobile application 1010 may use the upload URL to upload media for delivery instructions to the media storage 1030. The media for the delivery instructions may include a photo, text, a geolocation, and/or a digital representation of a package within three-dimensional space, as discussed herein.

The mobile application 1010 may update an address of the customer with the key of the media in the media storage 1030. The mobile application 1010 may transmit the key to the address database 1040 with a request to associate the key with the customer address in the address database 1040. In some implementations, the address database 1040 is or includes a key-value database.

In some implementations, the mobile application 1010 transmits the key with the corresponding request to the proxy 1020. In an example, the mobile application 1010 is a mobile application of a customer, and the proxy 1020 receives the key and corresponding request to authenticate the customer and/or protect the address database 1040 from malicious requests.

In some implementations, the key for the media in the media storage 1030 is based on an address key in the address database 1040. In an example, the key for the media includes the address key and/or a customer ID. In some implementations, the proxy 1020 adds the customer ID to the key for the media before returning the key for the media to the mobile application.

In some implementations, the media storage 1030 transmits the key for the media directly to the address database 1040.

In some implementations, the mobile application 1010 caches the media locally using the key for the media. In this way, the mobile application 1010 does not need to request the media each time the customer attempts to view the media. In this way, the mobile application conserves network bandwidth. In some implementations, the mobile application 1010 compares a timestamp of the cached media with a timestamp of a most recent update to the media and downloads the media if the timestamp of the cached media is older than the timestamp of the most recent update to the media.

The requests between the various components of the system 1000 may be or include API calls.

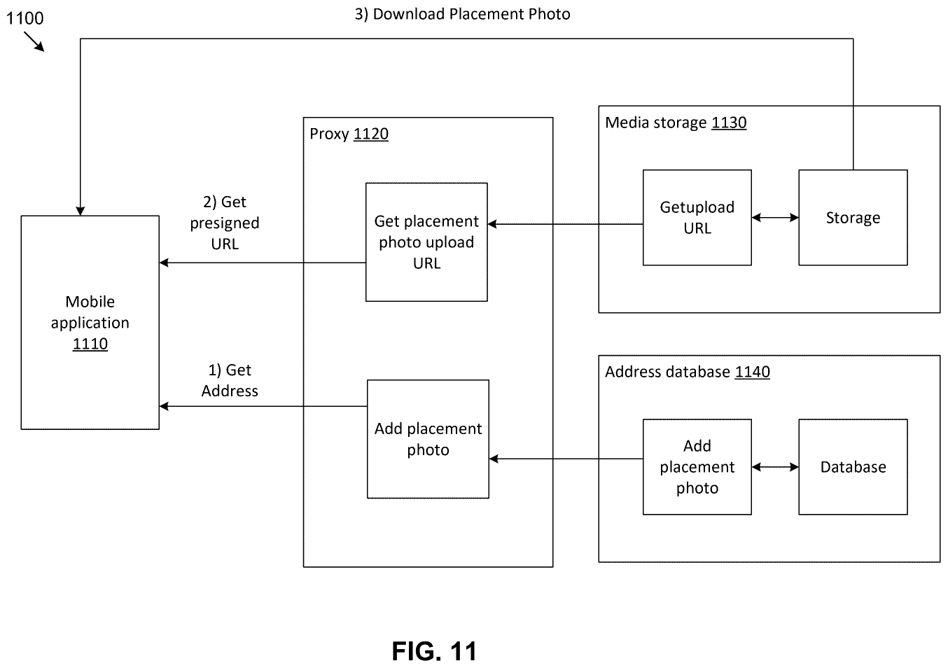

FIG. 11 is an example block diagram of a system 1100 for downloading visual media for delivery instructions. The system 1100 includes a mobile application 1110, a media storage 1130, and an address database 1140. In some implementations, the system 1100 includes a proxy 1120. In an example, the mobile application 1110 is a mobile application of a customer which communicates with the proxy 1120 to protect the media storage 1130 and the address database 1140 from malicious requests. In an example, the mobile application 1110 is a mobile application of a delivery person which communicates with the proxy 1120 to protect the media storage 1130 and the address database 1140 from malicious requests. In some implementations, the proxy 1120 includes separate proxies for each of the customer mobile application and the driver mobile application. In some implementations, the system 1100 is the same as the system 1000.

The mobile application 1110 may receive an order for a package to be delivered. The order may include an order ID. The mobile application 1110 may request an address associated with the order from the address database 1040. The mobile application 1110 may transmit an address request to the address database 1040 including the order ID. In some implementations, the mobile application 1110 transmits the request to the proxy 1120. In an example, the mobile application 1110 is a mobile application of a delivery person and communicates with the proxy 1120 to protect the address database 1140 from malicious requests.

The mobile application 1110 may request a presigned URL from the media storage 1130 to download media for delivery instructions for the order. The media storage 1130 may be a cloud storage, such as one or more AWS S3 buckets. In some implementations, the mobile application 1110 requests the presigned URL using the order ID. In some implementations, the mobile application 1110 requests the presigned URL using a key of the media received with the address from the address database 1040. In some implementations, the mobile application 1110 transmits the request to the proxy 1120. In an example, the mobile application 1110 is a mobile application of a delivery person and communicates with the proxy 1120 to protect the address database 1140 from malicious requests.

The mobile application 1110 may, using the presigned URL, download the media for the delivery instructions from the media storage 1130. The presigned URL may allow the mobile application 1110 to cache the media on the mobile device. In this way, the mobile device may, in subsequent access requests, conserve network bandwidth by retrieving the media from cache instead of downloading the media form the media storage 1130. In some implementations, the media is pre-fetched and cached by the mobile application 1110. In an example, the mobile application 1110 may download an AR overlay including a digital representation of a package in a delivery area when the mobile device is connected to a network and/or when a delivery person uses the mobile application 1110 to view scheduled deliveries. In this example, the delivery person may download media for delivery instructions, including images and AR overlays, when starting a delivery route such that the mobile application 1110 can retrieve the images and AR overlays from cache when the delivery person is delivering the packages. In this way, the mobile application 1110 may deliver the media (e.g., images and AR overlays) to the delivery person even when the mobile device has limited or no network connection. Similarly, the mobile application 1110 may queue images and/or messages for upload when the network connection improves.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method comprising:
transmitting, by a first mobile device, to a media storage, an upload URL request;
receiving, by the first mobile device, from the media storage, in response to the upload URL request, an upload URL including a key identifying a location in the media storage, wherein the upload URL allows for uploading media to the location in the media storage;
upload, by the first mobile device, using the upload URL, media to the location in the media storage indicated by the key in the upload URL, the media comprising delivery instructions for package placement;
transmitting by the first mobile device, to a geographic location database, an update request including the key, the update request to store, at the geographic location database, the key in association with a geographic location associated with the mobile device;
transmitting, by a second mobile device, to the geographic location database, a geographic location request including an operation identifier;
in response to the geographic location request, receiving, by the second mobile device, from the geographic location database, a geographic location and the key based on an association with the geographic location in the geographic location database;
transmitting, by the second mobile device, to a media storage, a download request comprising the presigned URL request including the key; and
in response to the download request, receiving, by the second mobile device, from the media storage, the media stored in the location in the media storage identified by the key.

2. The method of claim 1, further comprising obtaining, by the second mobile device an augmented reality (AR) overlay based on the media.

3. The method of claim 2, wherein generating the AR overlay includes creating a digital representation of a package having dimensions corresponding to dimensions of a physical package to be delivered and positioning the digital representation within a three-dimensional space corresponding to the delivery location.

4. The method of claim 2, further comprising overlaying, by the second mobile device, a camera feed of the second mobile device with the AR overlay.

5. The method of claim 4, further comprising:
capturing, by the second mobile device, a delivery confirmation photograph including physical package placement;
comparing the photograph to the AR overlay; and
determining whether the physical package placement matches the delivery instructions within a predetermined tolerance.

6. The method of claim 4, wherein determining whether the physical package placement matches the delivery instructions includes comparing a position and orientation of the physical package with a position and orientation of a digital representation of the package.

7. The method of claim 1, further comprising caching, by the second mobile device, the media on the second mobile device.

8. The method of claim 1, further comprising queuing, by the second mobile device, the download request based on limited network connectivity.

9. The method of claim 1, further comprising providing, by the second mobile device, real-time feedback regarding alignment between physical package placement and delivery instructions.

10. The method of claim 1, further comprising displaying, by the second mobile device, directional indicators guiding a user of the second mobile device to the geographic location.

11. The method of claim 1, further comprising:
capturing, by the second mobile device, a delivery confirmation photograph including physical package placement; and
transmitting, by the second mobile device, the delivery confirmation photograph to the media storage.

12. A system, comprising:
a media storage system;
a geographic location database;
one or more processors; and
a non-transitory, computer-readable medium including instructions which, when executed by the one or more processors, cause the one or more processors to:
receive, at the media storage, from a mobile device, an upload URL request;
transmit, by the media storage, in response to the upload URL request, an upload URL including a key identifying a location in the media storage, wherein the upload URL allows for uploading media to the location in the media storage;
store, in response to an upload from the mobile device using the upload URL, media from the mobile device in the location in the media storage indicated by the key in the upload URL, the media comprising delivery instructions for package placement;
receive, at the geographic location database, an update request including the key; and
in response to the update request, store, at the geographic location database, the key in association with a geographic location associated with the mobile device.

13. The system of claim 12, further comprising a proxy, wherein requests and responses between the system and the mobile device are transmitted via the proxy.

14. The system of claim 13, wherein the instructions cause the one or more processors to authenticate, by the proxy, the mobile device.

15. A system, comprising:
a media storage system;
a geographic location database;
one or more processors; and
a non-transitory, computer-readable medium including instructions which, when executed by the one or more processors, cause the one or more processors to:
receive, at the geographic location database, from a mobile device, a geographic location request including an operation identifier;
in response to the geographic location request, transmit, to the mobile device, a geographic location corresponding to the operation identifier and a key associated with the geographic location in the geographic location database, wherein the key identifies a location in the media storage;
receive, from the mobile device, at the media storage, a presigned URL request including the key; and
in response to a download request using the presigned URL from the mobile device, transmit, from the media storage to the mobile device, media stored in the location in the media storage identified by the key, the media comprising delivery instructions for package placement.

16. The system of claim 15, wherein the instructions cause the one or more processors to receive, from the mobile device, confirmation of delivery.

17. The system of claim 16, wherein the confirmation of delivery includes a delivery photo, and wherein the instructions cause the one or more processors to compare the media comprising the delivery instructions for package placement to the received delivery photo.

18. The system of claim 15, wherein the instructions cause the one or more processors to generate an augmented reality (AR) overlay based on the media.

19. The system of claim 18, wherein the instructions cause the one or more processors to generate the AR overlay based on the media by creating a digital representation of a package having dimensions corresponding to dimensions of a physical package to be delivered.

20. The system of claim 15, wherein the media comprises at least one of a photograph of a delivery location, geolocation data, and textual delivery instructions.
